(19) United States
(12) Patent Application Publication
(10) Pub. No.: US 2021/0061951 A1
(43) Pub. Date: Mar. 4, 2021

(54) METHOD FOR PRODUCING A POLYMER WHICH CONTAINS MULTIPLE BONDS AS AN ELASTOMER PRECURSOR

(71) Applicant: Covestro Deutschland AG, Leverkusen (DE)

(72) Inventors: Thomas Ernst Mueller, Aachen (DE); Christoph Guertler, Köln (DE); Muhammad Afzal Subhani, Aachen (DE); Rakibul Kabir, Manchester (GB); Walter Leitner, Aachen (DE)

(21) Appl. No.: 16/644,592

(22) PCT Filed: Sep. 26, 2018
(86) PCT No.: PCT/EP2018/076051

§ 371 Date: Mar. 5, 2020

(30) Foreign Application Priority Data
Sep. 28, 2017 (EP) 17193623.0

(51) Int. Cl. C08G 65/336; C08G 64/18; C08G 64/02

(52) U.S. Cl. CPC C08G 65/336; C08G 64/0266; C08G 64/183; C08G 64/186

(57) ABSTRACT

The invention relates to a method for producing a polymer which contains organooxysilyl end groups. The method first has the step of reacting a polyoxyalkylene polyol which contains carbon-carbon multiple bonds with a organooxysilyl compound of the formula Si(X)n(R)4-n in the presence of a catslyst, wherein X independently of one another represents C1-C8-alkoxy, C7-C20-aralkoxy, C6-C14-aroxy, C7-C20-alkylaroxy, C1-C20-acyloxy; R independently of one another represents a saturated or unsaturated C1-C22-alkyl, C6-C14-aryl, C7-C14-aralkyl, C7-C14-alkylaryl; and n is 2, 3, or 4. The invention additionally relates to a method for producing an elastomer precursor from the polymer which contains organooxysilyl end groups and to products which can be obtained using said method.

The present invention relates to a process for preparing a polymer containing organooxysilyl end groups and to a process for producing an elastomer precursor. It further relates to the products obtainable by these processes.

The preparation of polyethercarbonate polyols by catalytic reaction of alkylene oxides (epoxides) and carbon dioxide in the presence of H-functional starter substances (“starters”) has been the subject of intensive study for more than 40 years (e.g. Inoue et al., Copolymerization of Carbon Dioxide and Epoxide with Organometallic Compounds; Die Makromolekulare Chemie 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are each integers, and where the product shown here in scheme (I) for the polyethercarbonate polyol should merely be understood in such a way that blocks having the structure shown may in principle be present in the polyethercarbonate polyol obtained, but the sequence, number and length of the blocks and the OH functionality of the starter may vary, and it is not restricted to the polyethercarbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example, when R═CH₃, propylene carbonate).

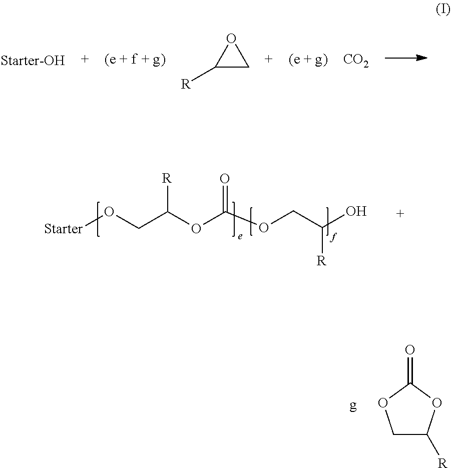

EP 2 845 872 Al discloses a process for preparing polyethercarbonate polyols with side chains, comprising the steps of: (α) initially charging a catalyst and: (αα) a suspension medium that does not contain any H-functional groups and/or (αβ) an H-functional starter substance; (γ) metering in carbon dioxide and at least two alkylene oxides, where these alkylene oxides may be the same as or different than the alkylene oxide(s) metered in in step (β), where the difference in the molecular weight of the lightest and heaviest of the alkylene oxides metered in in stage (γ) is not less than 24 g/mol and the lightest alkylene oxide is a C2-C4-alkylene oxide and where, in addition, if no H-functional starter substance has been initially charged in step (α), step (γ) comprises the metered addition of an H-functional starter substance. Also claimed is the use of the polyethercarbonate polyol as crosslinkable component within a crosslinking reaction for production of thermoset or elastomeric networks.

Unsaturated polyethercarbonate polyols are crosslinkable via their carbon-carbon multiple bonds. For instance, WO 2015/032645 A1 discloses a process for preparing mercapto-crosslinked polyethercarbonates, with reaction of polyethercarbonate polyols containing double bonds with polyfunctional mercaptans and/or sulfur with involvement of initiator compounds.

Another conceivable crosslinking reaction is the reaction of the unsaturated polyethercarbonate polyols with free-radical initiators. However, their molecular weight achievable according to the current prior art is too low at least by a factor of 10 for use of the unsaturated polyethercarbonate polyols in the production of elastomers.

One means of increasing the molecular weight prior to a crosslinking reaction could be the formation of Si—O—Si bridges. For this purpose, the functionality needed therefor must first be introduced into the polyol.

The publication by B. Kanner et al., I&EC Product Research and Development, 6(2), 1967, 88-92 describes a process for preparing siloxane-polyether copolymers that find use as surface-active substances. There is no mention of use of unsaturated polyethers.

DE 10 2008 000 360 A1 discloses the preparation of polyether alcohols bearing alkoxysilyl groups by alkoxylation of epoxy-functional alkoxysilanes using DMC catalysts. Also mentioned is copolymerization with a number of further comonomers, especially further epoxides, but also carbon dioxide. In example 6, DE 10 2008 000 360 A1 contains a specific example of the copolymerization of an epoxy-functional alkoxysilane with propylene oxide and carbon dioxide. The carbonate content achieved in this case is about 4% by weight.

WO 2012/136657 A1 relates to a process that allegedly allows the incorporation of a high proportion of carbon dioxide into the copolymer and at the same time the use of sensitive epoxides such as, in particular, epoxy-functional alkoxysilanes.

Neither of the latter patent applications discloses an increase in molecular weight by formation of Si—O—Si bridges. Moreover, the polyols in question do not contain any carbon-carbon double bonds.

In the prior art, terminal alkoxysilyl groups on polymeric polyols are introduced, for example, by a two-stage reaction sequence in which the OH groups of the polyol are deprotonated with a base and reacted with allyl halide. This is followed by a hydrosilylation with a compound such as dimethoxymethylsilane (MeO)₂Si(H)Me. U.S. Pat. No. 6,437,071 is a representative of such publications. After the hydrosilylation, the polyols in question do not contain any C═C double bonds.

EP 1 509 533 A1 discloses a method of preparing organic polyol silanes, wherein the method comprises: (a) combining at least one alkoxysilane with one or more organic polyols either neat or in the presence of a polar solvent and heating to elevated temperatures for a sufficient period of time for the reaction of the alkoxysilane(s) with the organic polyol(s) to produce polyol-substituted silanes and alkoxy-derived alcohols without the use of a catalyst, wherein the polyol-substituted silanes contain no residual alkoxy groups; and (b) removal of the alkoxy-derived alcohols. If, as envisaged in this patent application, no residual alkoxy groups are present, there cannot be any increase in molecular weight either as a result of the intramolecular construction of Si—O—Si groups.

It is desirable to perform the preparation of elastomers in a two-stage process. In a first step, an elastomer precursor that has still not reacted to give a fixed three-dimensional network and is therefore processible on machines and especially formable is provided. The final crosslinking step that follows then affords the elastomer.

It is an object of the present invention to provide a process for preparing an elastomer precursor and the precursor thereof in which it is possible to use polyoxyalkylene polyols that are currently available regardless of their molecular weight.

In a first aspect, the object has been achieved in accordance with the invention by a process for preparing a polymer containing organooxysilyl end groups, wherein the process comprises the step of:

A) reacting a polyoxyalkylene polyol containing carbon-carbon double bonds, preferably a polyethercarbonate polyol containing carbon-carbon double bonds, with an organooxysilyl compound of the formula Si(X)n(R0)4-n in the presence of a catalyst (A),

where:

X is independently C1-C8-alkoxy, C7-C20-aralkoxy, C6-C14-aroxy, C7-C20-alkylaroxy, C1-C20-acyloxy;

R0 is independently saturated or unsaturated C1-C22-alkyl, C6-C14-aryl, C7-C14-aralkyl, C7-C14-alkylaryl

and n is 3 or 4.

In addition, the object has been achieved in a second aspect by a process for preparing an elastomer precursor, wherein the process comprises the step of:

B) heating a polymer containing organooxysilyl end groups as claimed in claim 11 to a temperature of ≥65° C. in the presence of a catalyst (B).

Without being limited to a theory, it is assumed that, in step A), the difunctional, trifunctional or tetrafunctional organooxysilyl compound reacts with free OH groups of the polyol to eliminate the corresponding alcohol. In step B), the molecular weight is then increased by intramolecular condensation, whereby the elastomer precursor can be obtained.

The inventive addition of an organooxysilyl compound to a polyoxyalkylene that has already been functionalized with at least one double bond enables an efficient and selective process regime. By contrast with in situ incorporation of compounds containing organooxysilyl groups by polymerization in the course of the terpolymerization for preparation of the polyoxyalkylene, for example by the addition of epoxy-functional silanes, the process of the invention allows much better control of the stoichiometric composition and the structure of the polymer in step A).

Thus, the synthesis regime of the invention avoids the risk of premature crosslinking of the polymer during the synthesis or workup in step A). More particularly, at the high polymerization temperatures, it would otherwise be possible to react the OH end groups of the OH-functional starter substances or of the polymer formed with the organooxysilyl groups under transetherification.

Furthermore, the use of epoxy-functional silanes, which is necessary in the prior art, can affect the reaction rates and/or the amount of CO₂ incorporated in a manner which is undesirable for the intended application of the polymers. The inventive synthesis regime in step A) with downstream organooxysilyl functionalization, by contrast, leads to a much greater number of degrees of process freedom.

Examples of polyoxyalkylene polyols suitable in accordance with the invention are polyether polyols, polyethercarbonate polyols, polyetherester polyols and/or polyetherestercarbonate polyols.

It is also possible to use mixtures of a plurality of polyols and/or organooxysilyl compounds.

The reaction in step A) is preferably conducted in accordance with the standards of common laboratory practice, i.e., more particularly, for a predetermined period of time, at a predetermined temperature, with monitoring of the progress of the reaction and with a purification of the reaction product.

The predetermined period of time may, for example, be ≥1 hour to ≤12 hours. Suitable reaction temperatures are especially ≥80° C. to ≤120° C. The progress of the reaction can appropriately be monitored by IR spectroscopy with reference to the decrease in the O—H stretch vibration band of the polyol reactant.

It is also favorable when the reaction product is purified after the predetermined reaction time. In this way, unwanted further reactions are avoided and the storage stability of the product obtained is improved. The purification is preferably effected by applying reduced pressure. For instance, unreacted organooxysilyl compounds and, at least to some degree, the catalyst may be removed.

Embodiments of the present invention and further aspects are elucidated hereinafter. These may be combined with one another as desired unless the opposite is apparent from the context.

In one embodiment of the process of the invention, the carbon-carbon multiple bond-containing polyoxyalkylene polyol is obtainable by adding alkylene oxide, carbon-carbon multiple bond-containing monomer and CO2 onto H-functional starter substance in the presence of a double metal cyanide catalyst.

Preferably, the proportion of the carbon-carbon multiple bond-containing monomer is ≥0.1% by weight to ≤60% by weight, preferably ≥0.5% by weight to ≤30% by weight and more preferably ≥1.0% by weight to ≤15% by weight, based on the total molar amount of alkylene oxide, carbon dioxide and the carbon-carbon multiple bond-containing monomer used.

For instance, the preparation of the polyoxyalkylene polyols containing double bonds may comprise the steps of:
(α) initially charging a catalyst and
   (αα) a suspension medium which contains no H-functional groups and/or
   (αβ) an H-functional starter substance,
(γ) metering in carbon dioxide and
at least two alkylene oxides, with at least one of the two epoxides having a double bond, or
an alkylene oxide and an unsaturated cyclic anhydride.

It is preferable here that this process further comprises the following step (β) between step (α) and step (γ):
(β) metering in at least one alkylene oxide, where the alkylene oxide(s) metered in in step (γ) may be the same as or different from the alkylene oxide or alkylene oxides metered in in step (β).

Through the choice of suitable unsaturated compounds in the synthesis of the polyoxyalkylene polyol containing multiple bonds, it is possible to obtain polymers having particularly favorable properties compared to the prior art. The polyoxyalkylene polyols containing multiple bonds can be obtained reproducibly in a high yield and, as a result of the chosen process regime, have a narrow molecular mass distribution and only a very small fraction of unreacted monomers. Through incorporation of cyclic anhydrides into the polymer chain formed, the polyoxyalkylene polyol formed may additionally contain ester groups as well as ether groups and carbonate groups.

Furthermore, within one preferred embodiment of the process for preparing the polyoxyalkylene polyols containing multiple bonds, the temperature in step (γ) may be greater than or equal to 60° C. and less than or equal to 150° C. This temperature range during the polymerization has proven particularly suitable for synthesis of the polyoxyalkylene polyols containing multiple bonds with a sufficient reaction rate and with a high selectivity. In the range of lower temperatures, the reaction rate which comes about may only be inadequate, and, at higher temperatures, the fraction of unwanted by-products may increase too greatly.

In the usable process of the invention, monomers without unsaturated groups that can be used are alkylene oxides having 2-45 carbon atoms and bearing no multiple bond. The alkylene oxides having 2-45 carbon atoms are, for example, one or more compounds selected from the group comprising ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, alkylene oxides of C6-C22 α-olefins, such as 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example glycidyl ethers of C1-C22 alkanols and glycidyl esters of C1-C22 alkanecarboxylic acids. Examples of derivatives of glycidol are phenyl glycidyl ether, cresyl glycidyl ether, methyl glycidyl ether, ethyl glycidyl ether and 2-ethylhexyl glycidyl ether. Alkylene oxides used may preferably be ethylene oxide and/or propylene oxide, especially propylene oxide.

In addition, for the preparation of the polyoxyalkylene polyols containing multiple bonds that are usable in accordance with the invention, an H-functional starter substance is used.

The suspension media that are used in step (a) for suspending the DMC catalyst contain no H-functional groups.

Suitable suspension media are any polar aprotic, weakly polar aprotic and nonpolar aprotic solvents, none of which contain any H-functional groups. Suspension media used may also be a mixture of two or more of these suspension media. The following polar aprotic solvents are mentioned here by way of example: 4-methyl-2-oxo-1,3-dioxolane (also referred to below as cyclic propylene carbonate), 1,3-dioxolan-2-one, acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media used are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

In an alternative embodiment, one or more compounds selected from the group consisting of aliphatic lactones, aromatic lactones, lactides, cyclic carbonates having at least three optionally substituted methylene groups between the oxygen atoms of the carbonate group, aliphatic cyclic anhydrides and aromatic cyclic anhydrides are as suspension media employed in step (α) for suspending the DMC catalyst. Without being tied to a theory, suspension media of this kind are incorporated into the polymer chain in the subsequent course of the ongoing polymerization in the presence of a starter. As a result, there is no need for downstream purification steps.

Aliphatic or aromatic lactones are cyclic compounds containing an ester bond in the ring. Preferred compounds are 4-membered-ring lactones such as β-propiolactone, β-butyrolactone, β-isovalerolactone, β-caprolactone, β-isocaprolactone, β-methyl-β-valerolactone, 5-membered-ring lactones, such as γ-butyrolactone, γ-valerolactone, 5-methylfuran-2(3H)-one, 5-methylidenedihydrofuran-2(3H)-one, 5-hydroxyfuran-2(5H)-one, 2-benzofuran-1(3H)-one and 6-methyl-2-benzofuran-1(3H)-one, 6-membered-ring lactones, such as δ-valerolactone, 1,4-dioxan-2-one, dihydrocoumarin, 1H-isochromen-1-one, 8H-pyrano[3,4-b]pyridin-8-one, 1,4-dihydro-3H-isochromen-3-one, 7,8-dihydro-5H-pyrano[4,3-b]pyridin-5-one, 4-methyl-3,4-dihydro-1H-pyrano[3,4-b]pyridin-1-one, 6-hydroxy-3,4-dihydro-1H-isochromen-1-one, 7-hydroxy-3,4-dihydro-2H-chromen-2-one, 3-ethyl-1H-isochromen-1-one, 3-(hydroxymethyl)-1H-isochromen-1-one, 9-hydroxy-1H,3H-benzo[de]isochromen-1-one, 6,7-dimethoxy-1,4-dihydro-3H-isochromen-3-one and 3-phenyl-3,4-dihydro-1H-isochromen-1-one, 7-membered-ring lactones, such as E-caprolactone, 1,5-dioxepan-2-one, 5-methyloxepan-2-one, oxepane-2,7-dione, thiepan-2-one, 5-chlorooxepan-2-one, (4S)-4-(propan-2-yl)oxepan-2-one, 7-butyloxepan-2-one, 5-(4-aminobutyl)oxepan-2-one, 5-phenyloxepan-2-one, 7-hexyloxepan-2-one, (5S,7S)-5-methyl-7-(propan-2-yl)oxepan-2-one, 4-methyl-7-(propan-2-yl)oxepan-2-one, and lactones with higher numbers of ring members, such as (7E)-oxacycloheptadec-7-en-2-one.

Lactides are cyclic compounds containing two or more ester bonds in the ring. Preferred compounds are glycolide (1,4-dioxane-2,5-dione), L-lactide (L-3,6-dimethyl-1,4-dioxane-2,5-dione), D-lactide, DL-lactide, mesolactide and 3-methyl-1,4-dioxane-2,5-dione, 3-hexyl-6-methyl-1,4-dioxane-2,5-diones, 3,6-di(but-3-en-1-yl)-1,4-dioxane-2,5-dione (in each case inclusive of optically active forms). Particular preference is given to L-lactide.

Cyclic carbonates used are preferably compounds having at least three optionally substituted methylene groups between the oxygen atoms of the carbonate group. Preferred compounds are trimethylene carbonate, neopentyl glycol carbonate (5,5-dimethyl-1,3-dioxan-2-one), 2,2,4-trimethyl-1,3-pentanediol carbonate, 2,2-dimethyl-1,3-butanediol carbonate, 1,3-butanediol carbonate, 2-methyl-1,3-propanediol carbonate, 2,4-pentanediol carbonate, 2-methylbutane-1,3-diol carbonate, TMP monoallyl ether carbonate, pentaerythritol diallyl ether carbonate, 5-(2-hydroxyethyl)-1,3-dioxan-2-one, 5-[2-(benzyloxy)ethyl]-1,3-dioxan-2-one, 4-ethyl-1,3-dioxolan-2-one, 1,3-dioxolan-2-one, 5-ethyl-5-methyl-1,3-dioxan-2-one, 5,5-diethyl-1,3-dioxan-2-one, 5-methyl-5-propyl-1,3-dioxan-2-one, 5-(phenylamino)-1,3-dioxan-2-one and 5,5-dipropyl-1,3-dioxan-2-one. Particular preference is given to trimethylene carbonate and neopentyl glycol carbonate.

Under the conditions of the process of the invention for the copolymerization of alkylene oxides and CO₂, cyclic carbonates having fewer than three optionally substituted methylene groups between the oxygen atoms of the carbonate group are incorporated into the polymer chain not at all or only to a small extent.

However, cyclic carbonates having fewer than three optionally substituted methylene groups between the oxygen atoms of the carbonate group may be used together with other suspension media. Preferred cyclic carbonates having fewer than three optionally substituted methylene groups between the oxygen atoms of the carbonate group are ethylene carbonate, propylene carbonate, 2,3-butanediol carbonate, 2,3-pentanediol carbonate, 2-methyl-1,2-propanediol carbonate and 2,3-dimethyl-2,3-butanediol carbonate.

Cyclic anhydrides are cyclic compounds containing an anhydride group in the ring. Preferred compounds are succinic anhydride, maleic anhydride, phthalic anhydride, cyclohexane-1,2-dicarboxylic anhydride, diphenic anhydride, tetrahydrophthalic anhydride, methyltetrahydrophthalic anhydride, norbornenedioic anhydride and chlorination products thereof, succinic anhydride, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl)formamide and 3 [(2E)-but-2-en-1-yl]dihydrofuran-2,5-dione. Particular preference is given to succinic anhydride, maleic anhydride and phthalic anhydride.

The catalyst used for the preparation of the polyoxyalkylene polyols of the invention having multiple bonds is preferably a DMC catalyst (double metal cyanide catalyst). In addition or as sole catalysts it is also possible to use other catalysts for the copolymerization of alkylene oxides and CO₂ active catalysts, such as, for example, zinc carboxylates or cobalt-salen complexes. Examples of suitable zinc carboxylates are zinc salts of carboxylic acids, especially dicarboxylic acids such as adipic acid or glutaric acid. An overview of the known catalysts for the copolymerization of alkylene oxides and CO₂ is given for example by Chemical Communications 47 (2011) 141-163.

The double metal cyanide compounds present in DMC catalysts which can be used the process of the invention are the reaction products of water-soluble metal salts and water-soluble metal cyanide salts.

The term “terpolymerization” in the sense of the invention comprehends the polymerization of at least one alkylene oxide, at least one comonomer having a multiple bond (alkylene oxide and/or cyclic anhydride), and CO₂. Terpolymerization in the sense of the invention also includes, in particular, the copolymerization of a total of more than three monomers.

One embodiment of the process usable in accordance with the invention for preparing polyoxyalkylene polyols containing multiple bonds is characterized in that

(α) [first activation stage] a suspension medium containing no H-functional groups, an H-functional starter substance, a mixture of a suspension medium which contains no H-functional groups and an H-functional starter substance, or a mixture of at least two H-functional starter substances is initially charged, and water and/or other volatile compounds are optionally removed by elevated temperature and/or reduced pressure, with the DMC catalyst being added to the suspension medium which contains no H-functional groups, the H-functional starter substance, the mixture of a suspension medium which contains no H-functional groups and the H-functional starter substance, or the mixture of at least two H-functional starter substances, before or after the first activation stage,

(β) [second activation stage] a portion (based on the total amount of the amount of alkylene oxides used in steps (β) and (γ)) of one or more alkylene oxides is added to the mixture resulting from step (α), it being possible for the addition of a portion of alkylene oxide to take place optionally in the presence of CO₂ and/or inert gas (such as nitrogen or argon, for example), and it also being possible for step (β) to take place two or more times,

(γ) [polymerization stage] one or more alkylene oxides, at least one unsaturated compound (alkylene oxide and/or cyclic anhydride), and carbon dioxide are metered continually into the mixture resulting from step (β), and the alkylene oxides used for the terpolymerization may be the same as or different from the alkylene oxides used in step (β).

Step (α):

The addition of the individual components in step (α) may take place simultaneously or in succession in any order; preferably, in step (α), the DMC catalyst is introduced first, and, simultaneously or subsequently, the suspension medium which contains no H-functional groups, the H-functional starter substance, the mixture of a suspension medium which contains no H-functional groups and the H-functional starter substance, or the mixture of at least two H-functional starter substances is added.

A preferred embodiment provides a process in which, in step (α) [first activation stage],

(α1) a reactor is initially charged with the DMC catalyst and a suspension medium and/or one or more H-functional starter substances,

(α2) an inert gas (for example, nitrogen or a noble gas such as argon), an inert gas/carbon dioxide mixture, or carbon dioxide is passed through the reactor at a temperature of 50 to 200° C., preferably of 80 to 160° C., more preferably of 125 to 135° C., and at the same time a reduced pressure (absolute) of 10 mbar to 800 mbar, preferably of 40 mbar to 200 mbar, is set in the reactor by removal of the inert gas or carbon dioxide (with a pump, for example).

A further preferred embodiment provides a process in which, in step (α) [first activation stage],

(α1) a suspension medium which contains no H-functional groups, an H-functional starter substance, a mixture of a suspension medium which contains no H-functional groups and an H-functional starter substance, or a mixture of at least two H-functional starter substances is initially charged, optionally under inert gas atmosphere, under an atmosphere of inert gas/carbon dioxide mixture, or under a pure carbon dioxide atmosphere, more preferably under inert gas atmosphere, and

(α2) an inert gas, an inert gas/carbon dioxide mixture or carbon dioxide, more preferably inert gas, is introduced into the resulting mixture of the DMC catalyst and the suspension medium which contains no H-functional groups, the H-functional starter substance, the mixture of a suspension medium which contains no H-functional groups and the H-functional starter substance, or the mixture of at least two H-functional starter substances, at a temperature of 50 to 200° C., preferably of 80 to 160° C., more preferably of 125 to 135° C., and at the same time a reduced pressure (absolute) of 10 mbar to 800 mbar, preferably of 40 mbar to 200 mbar, is set in the reactor by removal of the inert gas or carbon dioxide (with a pump, for example),

it being possible for the double metal cyanide catalyst to be added to the suspension medium which contains no H-functional groups, the H-functional starter substance, the mixture of a suspension medium which contains no H-functional groups and the H-functional starter substance, or the mixture of at least two H-functional starter substances in step (al) or immediately thereafter in step (α2).

The DMC catalyst may be added in solid form or in suspension in a suspension medium and/or in an H-functional starter substance. If the DMC catalyst is added as a suspension, it is added preferably in step (α1) to the suspension medium and/or to the one or more H-functional starter substances.

Step (β):

Step (β) of the second activation stage may take place in the presence of CO₂ and/or inert gas. Step (β) preferably takes place under an atmosphere composed of an inert gas/carbon dioxide mixture (nitrogen/carbon dioxide or argon/carbon dioxide, for example) or a carbon dioxide atmosphere, more preferably under a carbon dioxide atmosphere. The establishment of an inert gas/carbon dioxide atmosphere or a carbon dioxide atmosphere and the metering of one or more alkylene oxides may take place in principle in different ways. The supply pressure is preferably established by introduction of carbon dioxide, where the pressure (in absolute terms) is 10 mbar to 100 bar, preferably 100 mbar to 50 bar and especially preferably 500 mbar to 50 bar. The start of the metered addition of the alkylene oxide may take place at any supply pressure chosen beforehand. The total pressure (in absolute terms) of the atmosphere is set in step (β) preferably in the range from 10 mbar to 100 bar, preferably 100 mbar to 50 bar, and more preferably 500 mbar to 50 bar. Optionally, during or after the metering of the alkylene oxide, the pressure is under closed-loop control by introduction of further carbon dioxide, with the pressure (absolute) being 10 mbar to 100 bar, preferably 100 mbar to 50 bar, and more preferably 500 mbar to 50 bar.

In one preferred embodiment, the amount of one or more alkylene oxides used in the activation in step (β) is 0.1% to 25.0% by weight, preferably 1.0% to 20.0% by weight, particularly preferably 2.0% to 16.0% by weight, based on the amount of suspension medium and/or H-functional starter substance used in step (α). The alkylene oxide may be added in one step or in a stepwise addition in two or more portions.

In one particularly preferred embodiment of the invention, a portion (based on the total amount of the amount of alkylene oxides used in steps (β) and (γ)) of one or more alkylene oxides, in the case of the activation in step (β) [second activation stage], is added to the mixture resulting from step (α), it being possible for the addition of a portion of alkylene oxide to take place optionally in the presence of CO₂ and/or inert gas. Step (β) may also take place more than once. The DMC catalyst is preferably used in an amount such that the amount of DMC catalyst in the resulting polyoxyalkylene polyol containing multiple bonds is 10 to 10 000 ppm, more preferably 20 to 5000 ppm and most preferably 50 to 500 ppm.

In the second activation step, the alkylene oxide may be added, for example, in one portion or over the course of 1 to 15 minutes, preferably 5 to 10 minutes. The duration of the second activation step is preferably 15 to 240 minutes, more preferably 20 to 60 minutes.

Step (γ):

The metering of the alkylene oxide(s), of the unsaturated compounds, also referred to below as monomers, and of the carbon dioxide may take place simultaneously, alternately, or sequentially, and the overall amount of carbon dioxide may be added all at once or in a metered way over the reaction time. During the addition of the monomers it is possible for the CO₂ pressure, gradually or in steps, to be raised or lowered or left the same. The total pressure is preferably kept constant during the reaction by metered addition of further carbon dioxide. The metering of the monomers may take place simultaneously, alternately, or sequentially to the metering of carbon dioxide. It is possible to meter the monomers at a constant metering rate or to raise or lower the metering rate continuously or in steps, or to add the monomers in portions. The monomers are preferably added at a constant metering rate to the reaction mixture. If two or more alkylene oxides are used for synthesis of the polyoxyalkylene polyols containing multiple bonds, the alkylene oxides may be metered in individually or as a mixture. The metered addition of the alkylene oxides can be effected simultaneously, alternately or sequentially, each via separate metering points (addition points), or via one or more metering points, in which case the alkylene oxides can be metered in individually or as a mixture. It is possible via the manner and/or sequence of the metered addition of the monomers and/or of the carbon dioxide to synthesize random, alternating, block-type or gradient-type polyoxyalkylene polyols containing multiple bonds.

Preference is given to using an excess of carbon dioxide, relative to the calculated amount of carbon dioxide required in the polyoxyalkylene polyol containing multiple bonds, since an excess of carbon dioxide is an advantage because of the reactive inertia of carbon dioxide. The amount of carbon dioxide can be specified by way of the total pressure. A total pressure (absolute) which has proven advantageous is the range from 0.01 to 120 bar, preferably 0.1 to 110 bar, more preferably from 1 to 100 bar, for the copolymerization for preparing the polyoxyalkylene polyols containing multiple bonds. It is possible to supply the carbon dioxide to the reaction vessel continuously or discontinuously. This is dependent on the rate at which the monomers and the CO₂ are consumed and on whether the product is to include optionally CO₂-free polyether blocks or blocks with different CO₂ contents. The concentration of the carbon dioxide may also vary during the addition of the monomers. Depending on the reaction conditions selected, it is possible for the CO₂ to be introduced into the reactor in the gaseous, liquid or supercritical state. CO₂ can also be added to the reactor in solid form and then be converted under the selected reaction conditions to the gaseous, dissolved, liquid and/or supercritical state.

In step (γ), the carbon dioxide can be introduced into the mixture, for example, by
(i) sparging the reaction mixture in the reactor from below,
(ii) using a hollow-shaft stirrer,
(iii) a combination of metering forms as per (i) and (ii), and/or
(iv) sparging via the surface of the liquid, by using multilevel stirring elements.

Step (γ) is conducted, for example, at temperatures of 60 to 150° C., preferably from 80 to 120° C., most preferably from 90 to 110° C. If temperatures below 60° C. are set, the reaction ceases. At temperatures above 150° C., the amount of unwanted by-products rises significantly.

The sparging of the reaction mixture in the reactor as per (i) is preferably effected by means of a sparging ring, a sparging nozzle, or by means of a gas inlet tube. The sparging ring is preferably an annular arrangement or two or more annular arrangements of sparging nozzles, preferably arranged at the bottom of the reactor and/or on the side wall of the reactor.

The hollow-shaft stirrer as per (ii) is preferably a stirrer in which the gas is introduced into the reaction mixture via a hollow shaft in the stirrer. The rotation of the stirrer in the reaction mixture (i.e. in the course of mixing) gives rise to a reduced pressure at the end of the stirrer paddle connected to the hollow shaft, such that the gas phase (containing CO₂ and any unconsumed monomers) is sucked out of the gas space above the reaction mixture and is passed through the hollow shaft of the stirrer into the reaction mixture.

The sparging of the reaction mixture as per (i), (ii), (iii) or (iv) can be effected with freshly metered-in carbon dioxide in each case and/or may be combined with a suctioning of the gas out of the gas space above the reaction mixture and subsequent recompression of the gas. For example, the gas sucked from the gas space above the reaction mixture and compressed, optionally mixed with fresh carbon dioxide and/or monomers, is introduced back into the reaction mixture as per (i), (ii), (iii) and/or (iv).

The pressure drop which comes about through incorporation of the carbon dioxide and the monomers into the reaction product in the terpolymerization is preferably balanced out by means of freshly metered carbon dioxide.

The monomers may be introduced separately or together with the CO₂, either via the liquid surface or directly into the liquid phase. The monomers are introduced preferably directly into the liquid phase, since this has the advantage of rapid mixing between the monomers introduced and the liquid phase, so preventing local concentration peaks of the monomers. The introduction into the liquid phase can be effected via one or more inlet tubes, one or more nozzles or one or more annular arrangements of multiple metering points, which are preferably arranged at the bottom of the reactor and/or on the side wall of the reactor.

The three steps (α), (β) and (γ) can be performed in the same reactor, or each can be performed separately in different reactors. Particularly preferred reactor types are stirred tanks, tubular reactors and loop reactors. If the reaction steps (α), (β) and (γ) are performed in different reactors, a different reactor type can be used for each step.

Polyoxyalkylene polyols containing multiple bonds can be prepared in a stirred tank, in which case the stirred tank, depending on design and mode of operation, is cooled via the reactor shell, internal cooling surfaces and/or cooling surfaces within a pumped circulation system. Both in semibatchwise application, in which the product is not removed until after the end of the reaction, and in continuous application, where the product is removed continuously, particular attention should be given to the metering rate of the monomers. It should be set so that, in spite of the inhibitory effect of the carbon dioxide, the monomers are depleted sufficiently rapidly by reaction. The concentration of free monomers in the reaction mixture during the second activation stage (step β) is preferably >0% to 100% by weight, more preferably >0% to 50% by weight, very preferably >0% to 20% by weight (based in each case on the weight of the reaction mixture). The concentration of free monomers in the reaction mixture during the reaction (step γ) is preferably >0% to 40% by weight, more preferably >0% to 25% by weight, very preferably >0% to 15% by weight (based in each case on the weight of the reaction mixture).

Another possible embodiment for the copolymerization (step y) is characterized in that one or more H-functional starter substances as well are metered continuously into the reactor during the reaction. In the case of performance of the process in semibatchwise operation, the amount of the H-functional starter substances which are metered continuously into the reactor during the reaction is preferably at least 20 mol % equivalents, more preferably 70 to 95 mol % equivalents (based in each case on the total amount of H-functional starter substances). When performing the process continuously, the amount of the H-functional starter substances metered into the reactor continuously during the reaction is preferably at least 80 mol % equivalents, particularly preferably 95 to 99.99 mol % equivalents (in each case based on the total amount of H-functional starter substances).

In one preferred embodiment, the catalyst/starter mixture activated in steps (α) and (β) is reacted further in the same reactor with the monomers and carbon dioxide. In another preferred embodiment, the catalyst/starter mixture activated in steps (α) and (β) is reacted further in a different reaction vessel (for example, a stirred tank, tubular reactor or loop reactor) with the monomers and carbon dioxide. In a further preferred embodiment, the catalyst/starter mixture prepared in step (α) is reacted in a different reaction vessel (for example, a stirred tank, tubular reactor or loop reactor) in steps (β) and (γ) with the monomers and carbon dioxide.

In the case of reaction in a tubular reactor, the catalyst/starter mixture prepared in step (α), or the catalyst/starter mixture activated in steps (α) and (β), and optionally further starters, and also the monomers and carbon dioxide, are pumped continuously through a tube. When a catalyst/starter mixture prepared in step (α) is used, the second activation stage in step (β) takes place in the first part of the tubular reactor, and the terpolymerization in step (γ) takes place in the second part of the tubular reactor. The molar ratios of the co-reactants vary according to the desired polymer.

In one process variant, carbon dioxide is metered in its liquid or supercritical form, in order to permit optimum miscibility of the components. The carbon dioxide can be introduced at the inlet of the reactor and/or via metering points which are arranged along the reactor, in the reactor. A portion of the monomers may be introduced at the inlet of the reactor. The remaining amount of the monomers is introduced into the reactor preferably via two or more metering points arranged along the reactor. Mixing elements of the kind sold, for example, by Ehrfeld Mikrotechnik BTS GmbH are advantageously installed for more effective mixing of the co-reactants, or mixer-heat exchanger elements, which at the same time improve mixing and heat removal. Preferably, the mixing elements mix CO₂ which is being metered in and the monomers with the reaction mixture. In an alternative embodiment, different volume elements of the reaction mixture are mixed with one another.

Loop reactors can likewise be used to prepare polyoxyalkylene polyols containing multiple bonds. These generally include reactors having internal and/or external material recycling (optionally with heat exchanger surfaces arranged in the circulation system), for example a jet loop reactor or Venturi loop reactor, which can also be operated continuously, or a tubular reactor designed in the form of a loop with suitable apparatuses for the circulation of the reaction mixture, or a loop of several series-connected tubular reactors or a plurality of series-connected stirred tanks

In order to achieve full conversion, the reaction apparatus in which step (γ) is carried out may frequently be followed by a further tank or a tube (“delay tube”) in which residual concentrations of free monomers present after the reaction are depleted by reaction. Preferably, the pressure in this downstream reactor is at the same pressure as in the reaction apparatus in which reaction step (γ) is performed. The pressure in the downstream reactor can, however, also be selected at a higher or lower level. In a further preferred embodiment, the carbon dioxide, after reaction step (γ), is fully or partly released and the downstream reactor is operated at standard pressure or a slightly elevated pressure. The temperature in the downstream reactor is preferably 10 to 150° C. and more preferably 20 to 100° C. At the end of the post-reaction time or at the outlet of the downstream reactor, the reaction mixture preferably contains less than 0.05 wt % of monomers. The post-reaction time or the residence time in the downstream reactor is preferably 10 min to 24 h, especially preferably 10 min to 3 h.

The polyoxyalkylene polyols containing multiple bonds that are obtainable preferably have an OH functionality (i.e., average number of OH groups per molecule) of at least 0.8, preferably of 1 to 8, more preferably of 1 to 6, and very preferably of 2 to 4. In an alternative embodiment, some of the OH groups are saturated with suitable reagents prior to the conversion of the polyoxyalkylene polyols to polymers containing organooxysilyl end groups, and so the resulting polyoxyalkylene polyol has an OH functionality of less than 0.8, preferably less than 0.5 and more preferably less than 0.1. In specific applications, this leads to a lower polarity of the elastomer precursor, thereby lowering, for example, the water absorption of the elastomers. Suitable reagents for the saturation of the OH functionalities are methylating agents, for example.

The molecular weight of the resulting polyoxyalkylene polyols containing multiple bonds is preferably at least 400, more preferably 400 to 1 000 000 g/mol and most preferably 500 to 60 000 g/mol.

Suitable H-functional starter substances (starters) used may be compounds having hydrogen atoms that are active in respect of the alkoxylation. Groups active in respect of the alkoxylation and having active hydrogen atoms are, for example, —OH, —NH₂ (primary amines), —NH— (secondary amines),

—SH, and —CO₂H, preferably —OH and —NH₂, more preferably —OH. As H-functional starter substance it is possible for there to be, for example, one or more compounds selected from the group comprising mono- or polyhydric alcohols, polyfunctional amines, polyfunctional thiols, amino alcohols, thio alcohols, hydroxy esters, polyether polyols, polyester polyols, polyesterether polyols, polyethercarbonate polyols, polycarbonate polyols, polycarbonates, polyethyleneimines, polyetheramines (e.g. so-called Jeffamine® products from Huntsman, such as D-230, D-400, D-2000, T-403, T-3000, T-5000 or corresponding products from BASF, such as Polyetheramine D230, D400, D200, T403, T5000), polytetrahydrofurans (e.g. PolyTHF® from BASF, such as PolyTHF® 250, 650S, 1000, 10005, 1400, 1800, 2000), polytetrahydrofuranamines (BASF product Polytetrahydrofuranamine 1700), polyetherthiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters which contain on average at least 2 OH groups per molecule. The C1-C23 alkyl fatty acid esters which contain on average at least 2 OH groups per molecule are, for example, commercial products such as Lupranol Balance® (BASF AG), Merginol® products (Hobum Oleochemicals GmbH), Sovermol® products (Cognis Deutschland GmbH & Co. KG), and Soyol®TM products (USSC Co.).

Monofunctional starter substances used may be alcohols, amines, thiols and carboxylic acids. Monofunctional alcohols used may be: methanol, ethanol, 1-propanol, 2-propanol, 1-butanol, 2-butanol, tert-butanol, 3-buten-1-ol, 3-Butyn-1-ol, 2-methyl-3-buten-2-ol, 2-methyl-3-Butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, tert-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Examples of polyhydric alcohols suitable as H-functional starter substances are dihydric alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentanetanediol, methylpentanediols (such as, for example, 3-methyl-1,5-pentanediol), 1,6-hexanediol; 1,8-octanediol, 1,10-decanediol, 1,12-dodecanediol, bis(hydroxymethyl)cyclohexanes (such as, for example, 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (such as, for example, trimethylolpropane, glycerol, trishydroxyethyl isocyanurate, castor oil); tetrahydric alcohols (such as, for example, pentaerythritol); polyalcohols (such as, for example, sorbitol, hexitol, sucrose, starch, starch hydrolyzates, cellulose, cellulose hydrolyzates, hydroxy-functionalized fats and oils, especially castor oil), and also all modification products of these aforementioned alcohols with different amounts of ϵ-caprolactone.

The H-functional starter substances may also be selected from the substance class of the polyether polyols, especially those having a molecular weight Mₙ in the range from 100 to 4000 g/mol. Preference is given to polyether polyols formed from repeat ethylene oxide and propylene oxide units, preferably having a proportion of propylene oxide units of 35% to 100%, particularly preferably having a proportion of propylene oxide units of 50% to 100%. These may be random copolymers, gradient copolymers, alternating copolymers or block copolymers of ethylene oxide and propylene oxide. Suitable polyether polyols formed from repeat propylene oxide and/or ethylene oxide units are, for example, the Desmophen®, Acclaim®, Arcol®, Baycoll®, Bayfill®, Bayflex®, Baygal®, PET® and polyether polyols from Bayer MaterialScience AG (for example Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are, for example, the Pluriol® E products from BASF SE, suitable homopolypropylene oxides are, for example, the Pluriol® P products from BASF SE; suitable mixed copolymers of ethylene oxide and propylene oxide are, for example, the Pluronic® PE or Pluriol® RPE products from BASF SE.

The H-functional starter substances may also be selected from the substance class of the polyester polyols, especially those having a molecular weight Mₙ in the range from 200 to 4500 g/mol. Polyester polyols used may be at least difunctional polyesters. Preferably, polyester polyols consist of alternating acid and alcohol units. Examples of acid components which can be used include succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, or mixtures of the stated acids and/or anhydrides. Examples of alcohol components used include ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, pentaerythritol, or mixtures of the stated alcohols. If the alcohol components used are dihydric or polyhydric polyether polyols, the result is polyesterether polyols which can likewise serve as starter substances for preparation of the polyoxyalkylene polyols. Preference is given to using polyether polyols with Mₙ=150 to 2000 g/mol for preparation of the polyesterether polyols.

As H-functional starter substances it is additionally possible to use polycarbonate diols, especially those having a molecular weight Mₙ in the range from 150 to 4500 g/mol, preferably 500 to 2500 g/mol, which are prepared, for example, by reaction of phosgene, dimethyl carbonate, diethyl carbonate or diphenyl carbonate and difunctional alcohols or polyester polyols or polyether polyols. Examples relating to polycarbonates are found for example in EP-A 1359177. As polycarbonate diols it is possible for example to use the Desmophen° C. grades from Bayer MaterialScience AG, such as Desmophen® C. 1100 or Desmophen® C. 2200, for example.

In a further embodiment of the invention, it is possible to use polyethercarbonate polyols (for example cardyon® polyols from Covestro), polycarbonate polyols (for example Converge® polyols from Novomer/Saudi Aramco, NEOSPOL polyols from Repsol etc.) and/or polyetherestercarbonate polyols as H-functional starter substance. In particular, polyethercarbonate polyols, polycarbonate polyols and/or polyetherestercarbonate polyols may be obtained by reaction of alkylene oxides, preferably ethylene oxide, propylene oxide or mixtures thereof, optionally further comonomers, with CO2 in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No.7,304,172 B2, US 2012/0165549 A1) and/or manganese salen complexes. An overview of known catalysts for the copolymerization of alkylene oxides and CO2 is provided for example by Chemical Communications 47 (2011) 141-163. The use of different catalyst systems, reaction conditions and/or reaction sequences results in the formation of random, alternating, block-type or gradient-type polyethercarbonate polyols, polycarbonate polyols and/or polyetherestercarbonate polyols. To this end, these polyethercarbonate polyols, polycarbonate polyols and/or polyetherestercarbonate polyols used as H-functional starter compounds may be prepared in a separate reaction step beforehand. The H-functional starter substances generally have an OH functionality (i.e. the number of H atoms active in respect of the polymerization per molecule) of 1 to 8, preferably of 2 to 6 and more preferably of 2 to 4. The H-functional starter substances are used either individually or as a mixture of at least two H-functional starter substances.

Preferred H-functional starter substances are alcohols with a composition according to the general formula,

HO—(CH₂)ₓ—OH (II)

where x is a number from 1 to 20, preferably an integer from 2 to 20. Examples of alcohols of formula (II) are ethylene glycol, butane-1,4-diol, hexane-1,6-diol, octane-1,8-diol, decane-1,10-diol and dodecane-1,12-diol. Further preferred H-functional starter substances are neopentyl glycol, trimethylolpropane, glycerol, pentaerythritol, reaction products of the alcohols of formula (II) with ϵ-caprolactone, e.g. reaction products of trimethylolpropane with ϵ-caprolactone, reaction products of glycerol with ϵ-caprolactone, and reaction products of pentaerythritol with ϵ-caprolactone. Preference is further given to using, as H-functional starter substances, water, diethylene glycol, dipropylene glycol, castor oil, sorbitol and polyether polyols formed from repeat polyalkylene oxide units.

More preferably, the H-functional starter substances are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol has been formed from a di- or tri-H-functional starter substance and propylene oxide or a di- or tri-H-functional starter substance, propylene oxide and ethylene oxide. The polyether polyols preferably have an OH functionality of 2 to 4 and a molecular weight Mₙ in the range from 62 to 4500 g/mol and more particularly a molecular weight Mₙ in the range from 62 to 3000 g/mol.

Double metal cyanide (DMC) catalysts for use in the homopolymerization of alkylene oxides are known in principle from the prior art (see, for example, U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086, WO 98/16310 and WO 00/47649, have a very high activity and enable the preparation of polyoxyalkylenes at very low catalyst concentrations. A typical example are the high-activity DMC catalysts described in EP-A 700 949, which in addition to a double metal cyanide compound (e.g. zinc hexacyanocobaltate(III)) and an organic complex ligand (e.g. tert-butanol) also include a polyether having a number-average molecular weight of more than 500 g/mol.

The DMC catalysts which can be used in accordance with the invention are preferably obtained by

(1.) in the first step, reacting an aqueous solution of a metal salt with the aqueous solution of a metal cyanide salt in the presence of one or more organic complex ligands, e.g. an ether or alcohol,

(2.) in the second step, using known techniques (such as centrifuging or filtering) to remove the solid from the suspension obtained from (a),

(3.) optionally, in a third step, washing the isolated solid with an aqueous solution of an organic complex ligand (e.g. by resuspending and subsequently again isolating by filtering or centrifuging),

(4.) and subsequently drying the resulting solid, optionally after pulverizing, at temperatures of in general 20-120° C. and at pressures of in general 0.1 mbar to atmospheric pressure (1013 mbar),

and wherein, in the first step or immediately after the precipitation of the double metal cyanide compound (second step), one or more organic complex ligands, preferably in excess (based on the double metal cyanide compound), and optionally further complex-forming components are added.

The double metal cyanide compounds included in the DMC catalysts which can be used in accordance with the invention are the reaction products of water-soluble metal salts and water-soluble metal cyanide salts.

For example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the resulting suspension.

Metal salts suitable for preparing the double metal cyanide compounds preferably have a composition according to the general formula (III),

M(X)ₙ (III),

where

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 if X=sulfate, carbonate or oxalate and

n is 2 if X=halide, hydroxide, carboxylate, cyanate, thiocyanate, isocyanate, isothiocyanate or nitrate,

or suitable metal salts preferably have a composition according to the general formula (IV)

Mᵣ(X)₃ (IV),

where

M is selected from the metal cations Fe³⁺, Al³⁺, Co³⁺ and Cr³⁺,

X comprises one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

r is 2 if X=sulfate, carbonate or oxalate and

r is 1 if X=halide, hydroxide, carboxylate, cyanate, thiocyanate, isocyanate, isothiocyanate or nitrate,

or suitable metal salts preferably have a composition according to the general formula (V),

M(X)ₛ (V),

where

M is selected from the metal cations Mo⁴⁺, V⁴⁺ and W⁴⁺,

X comprises one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 if X=sulfate, carbonate or oxalate and

s is 4 if X=halide, hydroxide, carboxylate, cyanate, thiocyanate, isocyanate, isothiocyanate or nitrate,

or suitable metal salts preferably have a composition according to the general formula (VI),

M(X)ₜ (VI),

where

M is selected from the metal cations Mo⁶⁺ and W⁶⁺,

X comprises one or more (i.e. different) anions, preferably anions selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

t is 3 if X=sulfate, carbonate or oxalate and

t is 6 if X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have a composition according to the general formula (VII)

(Y)ₐ M′(CN)_{b} (A)_{c} (VII),

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and

a, b and c are integers, the values for a, b and c being selected such as to ensure the electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds included in the DMC catalysts which can be used in accordance with the invention are compounds having compositions according to the general formula (VIII)

Mₓ[M′ₓ,(CN)_{y}]_{z} (VIII),

in which M is defined as in the formulae (III) to (VI) and

M′ is defined as in formula (VII), and

x, x′, y and z are integral and are selected such as to ensure the electronic neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). With particular preference it is possible to use zinc hexacyanocobaltate(III).

The organic complex ligands which can be added in the preparation of the DMC catalysts are disclosed in, for example, U.S. Pat. No. 5,158,922 (see, in particular, column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). For example, organic complex ligands used are water-soluble organic compounds having heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof.

Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds which include both aliphatic or cycloaliphatic ether groups and aliphatic hydroxyl groups (such as ethylene glycol mono-tert-butyl ether, diethylene glycol mono-tert-butyl ether, tripropylene glycol monomethyl ether and 3-methyl-3-oxetanemethanol, for example). Extremely preferred organic complex ligands are selected from one or more compounds of the group consisting of dimethoxyethane, tert-butanol 2-methyl-3-buten-2-ol, 2-methyl-3-butyn-2-ol, ethylene glycol mono-tert-butyl ether and 3-methyl-3-oxetanemethanol.

In the preparation of the DMC catalysts that can be used in accordance with the invention, one or more complex-forming components are optionally used from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid copolymers and maleic anhydride copolymers, hydroxyethylcellulose and polyacetals, or of the glycidyl ethers, glycosides, carboxylic esters of polyhydric alcohols, bile acids or salts, esters or amides thereof, cyclodextrins, phosphorus compounds, α,β-unsaturated carboxylic esters, or ionic surface-active or interface-active compounds.

In the preparation of the DMC catalysts that can be used in accordance with the invention, preference is given to using the aqueous solutions of the metal salt (e.g. zinc chloride) in the first step in a stoichiometric excess (at least 50 mol %) relative to the metal cyanide salt. This corresponds at least to a molar ratio of metal salt to metal cyanide salt of 2.25:1.00. The metal cyanide salt (e.g. potassium hexacyanocobaltate) is reacted in the presence of the organic complex ligand (e.g. tert-butanol) to form a suspension which contains the double metal cyanide compound (e.g. zinc hexacyanocobaltate), water, excess metal salt, and the organic complex ligand.

This organic complex ligand may be present in the aqueous solution of the metal salt and/or of the metal cyanide salt, or it is added directly to the suspension obtained after precipitation of the double metal cyanide compound. It has proven advantageous to mix the metal salt and metal cyanide salt aqueous solutions and the organic complex ligand by stirring vigorously. Optionally, the suspension formed in the first step is subsequently treated with a further complex-forming component. The complex-forming component is preferably used in a mixture with water and organic complex ligand. A preferred process for performing the first step (i.e. the preparation of the suspension) is effected using a mixing nozzle, more preferably using a jet disperser, as described, for example, in WO-A 01/39883.

In the second step, the solid (i.e. the precursor of the catalyst) can be isolated from the suspension by known techniques, such as centrifugation or filtration.

In a preferred variant, the isolated solids, in a third process step, are then washed with an aqueous solution of the organic complex ligand (for example by resuspension and subsequent reisolation by filtration or centrifugation). In this way, for example, water-soluble by-products, such as potassium chloride, can be removed from the catalyst that can be used in accordance with the invention. The amount of the organic complex ligand in the aqueous wash solution is preferably between 40 and 80 wt %, based on the overall solution.

Optionally in the third step the aqueous wash solution is admixed with a further complex-forming component, preferably in the range between 0.5% and 5% by weight, based on the overall solution.

It is also advantageous to wash the isolated solids more than once. In a first washing step (3.-1), washing takes place preferably with an aqueous solution of the unsaturated alcohol (for example by resuspension and subsequent reisolation by filtration or centrifugation), in order thereby to remove, for example, water-soluble by-products, such as potassium chloride, from the catalyst usable in accordance with the invention. The amount of the unsaturated alcohol in the aqueous wash solution is more preferably between 40% and 80% by weight, based on the overall solution of the first washing step. In the further washing steps (3.-2), either the first washing step is repeated one or more times, preferably from one to three times, or, preferably, a nonaqueous solution, such as a mixture or solution of unsaturated alcohol and further complex-forming component (preferably in the range between 0.5% and 5% by weight, based on the total amount of the wash solution of step (3.-2)), is employed as the wash solution, and the solid is washed with it one or more times, preferably one to three times.

The isolated and optionally washed solid can then be dried, optionally after pulverization, at temperatures of 20-100° C. and at pressures of 0.1 mbar to atmospheric pressure (1013 mbar).

One preferred method for isolating the DMC catalysts that can be used in accordance with the invention from the suspension by filtration, filtercake washing and drying is described in WO-A 01/80994.

The unsaturated comonomers may be distributed randomly or in blocks in the polyoxyalkylene polyols containing multiple bonds. Gradient polymers can also be used.

In a further embodiment of the method, the unsaturated cyclic anhydrides metered in in step (γ) may be selected from the group encompassing 4-cyclohexene-1,2-dioic anhydride, 4-methyl-4-cyclohexene-1,2-dioic anhydride, 5,6-norbornene-2,3-dioic anhydride, allyl-5,6-norbornene-2,3-dioic anhydride, dodecenylsuccinic anhydride, tetradecenylsuccinic anhydride, hexadecenylsuccinic anhydride or octadecenylsuccinic anhydride.

It is further preferable that the at least one carbon-carbon multiple bond-containing monomer is selected from at least one of the monomers from one or more of the groups consisting of
(a) allyl glycidyl ether, vinylcyclohexene oxide, cyclooctadiene monoepoxide, cyclododecatriene monoepoxide, butadiene monoepoxide, isoprene monoepoxide, limonene oxide, 1,4-divinylbenzene monoepoxide, 1,3-divinylbenzene monoepoxide, glycidyl esters of unsaturated fatty acids, partly epoxidized fats and oils and/or mixtures thereof
(b) alkylene oxide with double bond of the general formula (IX):

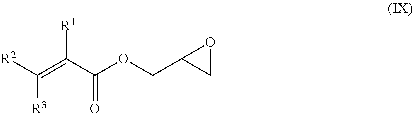

where R₁ to R₃ are independently H, halogen, substituted or unsubstituted C1-C22 alkyl or substituted or unsubstituted C6-C12 aryl
(c) cyclic anhydride of the general formula (X), (XI) or (XII):

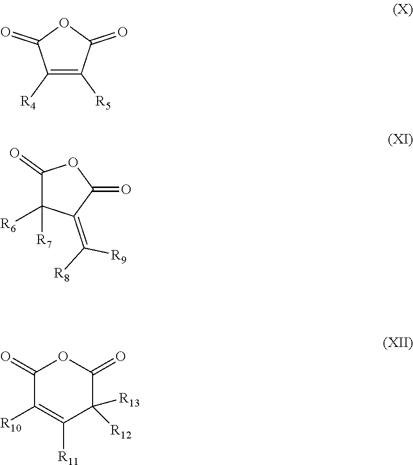

where R₁ to R₁₀ are independently H, halogen, substituted or unsubstituted C1-C22 alkyl or substituted or unsubstituted C6-C12 aryl,
(d) 4-cyclohexene-1,2-dioic anhydride, 4-methyl-4-cyclohexene-1,2-dioic anhydride, 5,6-norbornene-2,3-dioic anhydride, allyl-5,6-norbornene-2,3-dioic anhydride, dodecenylsuccinic anhydride, tetradecenylsuccinic anhydride, hexadecenylsuccinic anhydride and octadecenylsuccinic anhydride and
(e) alkylene oxide with triple bond of the general formula (XIII):

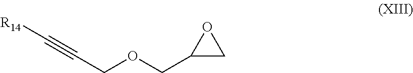

R14 is independently saturated or unsaturated C1-C22-alkyl, C6-C14-aryl, C7-C14-aralkyl, C7-C14-alkylaryl.

More preferably, the at least one carbon-carbon multiple bond-containing monomer is selected from one or more of the groups consisting of
(a) allyl glycidyl ether, vinylcyclohexene oxide and limonene oxide,
(b) glycidyl acrylate and glycidyl methacrylate,
(c) maleic anhydride and itaconic anhydride, cis-1,2,3,6-tetrahydrophthalic anhydride
(d) 4-cyclohexene-1,2-dioic anhydride and 5,6-norbornene-2,3-dioic anhydride and
(e) glycidyl propargyl ether.

It is further preferable that the polyethercarbonate polyol containing carbon-carbon multiple bonds has a CO2 content of 3% by weight to 44% by weight, preferably of 5% by weight to 25% by weight.

Very particular preference is given to using maleic anhydride, itaconic anhydride and cis-1,2,3,6-tetrahydrophthalic anhydride.

The alkylene oxide (=epoxide) preferably comprises ethylene oxide, propylene oxide and/or styrene oxide, more preferably ethylene oxide and/or propylene oxide.

With regard to the H-functional starter substance, it is preferable that the H-functional starter substance used is a polyol. In this reaction, preference is given to using a polyoxyalkylene polyol containing carbon-carbon double bonds, more preferably a carbon-carbon multiple bond-containing polyethercarbonate polyol.

In a further characteristic of the method, the alkylene oxides with multiple bond metered in in step (γ) may have been selected from the group encompassing allyl glycidyl ether, vinylcyclohexene oxide, cyclooctadiene monoepoxide, cyclododecatriene monoepoxide, butadiene monoepoxide, isoprene monoepoxide and/or limonene oxide.

In a further embodiment of the process of the invention, the polyoxyalkylene polyol containing multiple bonds may have a proportion of unsaturated comonomers of greater than or equal to 0.1 mol % and less than or equal to 50 mol %. In the course of the further functionalization of the polyoxyalkylene polyols containing multiple bonds that are used in accordance with the invention, the provision of a defined number of functionalizing means within the range specified above has been found to be particularly advantageous. This means that approximately every 2nd to every 1000th monomer unit within the polymer chain in the polyoxyalkylene polyol used in accordance with the invention bears an unsaturated group and, accordingly, is able to react in the course of a further reaction with free radicals. The proportion of unsaturated comonomers in the to polyoxyalkylene polyols may further be preferably not less than 0.5 mol % and not more than 15 mol %, more particularly not less than 1.0 mol % and not more than 10 mol %.

In the process of the invention relating to step A), in a further embodiment, the organooxysilyl compound selected is at least one compound from one or more of the groups consisting of trimethoxysilane, methyltrimethoxysilane, phenyltrimethoxysilane, triethoxysilane, methyltriethoxysilane, methyltripropoxysilane, hexadecyltrimethoxysilane, octodecyltrimethoxysilane, n-octyltrimethoxysilane, n-octyltriethoxysilane, propyltrimethoxysilane, propyltriethoxysilane, N-butyltrimethoxysilane, n-butyltriethoxysilane, iso-butyltriethoxysilane, 3-chloropropyltrimethoxysilane, 3-chloropropyltriethoxysilane, 3-chloropropylmethyldiethoxysilane, chloromethyltrimethoxysilane, chloromethyltriethoxysilane, dichloromethyltriethoxysilane, tetramethoxysilane, tetraethoxysilane and tetraisopropoxysilane.

In a preferred embodiment, the organooxysilyl compound is at least one compound is selected from the groups consisting of trimethoxysilane, triethoxysilane, tetramethoxysilane, tetraethoxysilane and tetraisopropoxysilane.

Preferably, this compound is used in excess, for example in a molar ratio of ≥10:1 to ≤50:1, based on the OH groups in the polyol.

In one embodiment of the process of the invention, the catalyst (A) used in step A) is selected from the group consisting of:
(a) amines of the general formula (XIV):

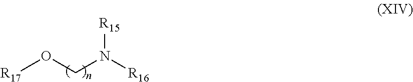

where:
   R15 and R16 are independently hydrogen, alkyl or aryl; or
   R15 and R16 together with the nitrogen atom supporting them form an aliphatic, unsaturated or aromatic heterocycle;
   n is an integer from 1 to 10;
   R17 is hydrogen, alkyl or aryl; or
   R17 is —(CH2)x—N(R18)(R19) where:
   R18 and R19 are independently hydrogen, alkyl or aryl; or
   R18 and R19 together with the nitrogen atom supporting them form an aliphatic, unsaturated or aromatic heterocycle;
   x is an integer from 1 to 10;
(b) amines of the general formula (XV):

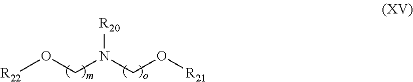

where:
R20 is hydrogen, alkyl or aryl;
R21 and R22 are independently hydrogen, alkyl or aryl;
m and o are independently an integer from 1 to 10;
and/or:

(c) diazabicyclo[2.2.2]octane, diazabicyclo[5.4.0]undec-7-ene, dialkylbenzylamine, dimethylpiperazine, 2,2′-dimorpholinyl diethyl ether, 4-dimethylaminopyridine and pyridine.

In a preferred embodiment of the process of the invention, the catalyst (A) used in step A) is selected from the group consisting of diazabicyclo[2.2.2]octane, diazabicyclo[5.4.0]undec-7-ene and 4-dimethylaminopyridine.

The present invention further relates to a polymer containing organooxysilyl end groups, obtainable by a process of the invention. Preferably, this polymer has a number-average molecular weight Mₙ of ≥500 g/mol to ≤100 000 g/mol, more preferably ≥1000 g/mol to ≤50 000 g/mol, and most preferably of in particular of ≥5000 g/mol to ≤8000 g/mol. The number-average molecular weight Mₙ and the weight-average molecular weight M_{w} can be determined by means of gel permeation chromatography (GPC). The procedure is according to DIN 55672-1: “Gel permeation chromatography, Part 1—Tetrahydrofuran as eluent” (example: SECurity GPC System from PSS Polymer Service, flow rate 1.0 ml/min; columns: 2×PSS SDV linear M, 8×300 mm, 5 μm; RID detector). Polystyrene samples of known molar mass are used for calibration.

As already mentioned above, a further aspect of the present invention is a process for preparing an elastomer precursor, wherein the process comprises the step of:
B) heating a polymer containing organooxysilyl end groups according to the present invention to a temperature of ≥65° C. in the presence of a catalyst.

The temperature may especially be ≥75° C. to ≤180° C., and preferably ≥80° C. to ≤130° C.

In one embodiment of the process of the invention, the catalyst (B) used in step B) is selected from the group consisting of:
(a) amines of the general formula (XIV):

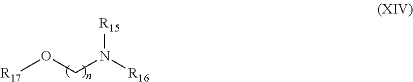

where:
   R15 and R16 are independently hydrogen, alkyl or aryl; or
   R15 and R16 together with the nitrogen atom supporting them form an aliphatic, unsaturated or aromatic heterocycle;
   n is an integer from 1 to 10;
   R17 is hydrogen, alkyl or aryl; or
   R17 is —(CH2)x—N(R18)(R19) where:
   R18 and R19 are independently hydrogen, alkyl or aryl; or
   R18 and R19 together with the nitrogen atom supporting them form an aliphatic, unsaturated or aromatic heterocycle;
   x is an integer from 1 to 10;
   (b) amines of the general formula (XV):

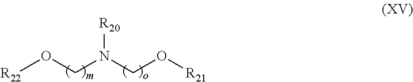

where:
R20 is hydrogen, alkyl or aryl;
R21 and R22 are independently hydrogen, alkyl or aryl;
m and o are independently an integer from 1 to 10;
and/or:
(c) diazabicyclo[2.2.2]octane, diazabicyclo[5.4.0]undec-7-ene, dialkylbenzylamine, dimethylpiperazine, 2,2′-dimorpholinyl diethyl ether, 4-dimethylaminopyridine and pyridine.

In a preferred embodiment of the process of the invention, the catalyst (B) used in step B) is selected from the group consisting of diazabicyclo[2.2.2]octane, diazabicyclo[5.4.0]undec-7-ene and 4-dimethylaminopyridine.

In one embodiment of the process of the invention, the catalyst (A) used in step A) is identical to the catalyst (B) used in step B) and is selected from the group consisting of diazabicyclo[2.2.2]octane, diazabicyclo[5.4.0]undec-7-ene and 4-dimethylaminopyridine.

In one embodiment of the process of the invention, the mass ratio of the catalyst (A) used in step A) is 1% by weight to 100% by weight, preferably 1% by weight to 20% by weight and more preferably 1% by weight to 10% by weight, based on the mass of the polyoxyalkylene polyol containing carbon-carbon multiple bonds, organooxysilyl compound and the catalyst (A).

In one embodiment of the process according to the invention, the mass ratio of the catalyst (B) used in step B) is 1% by weight to 100% by weight, preferably 1% by weight to 20% by weight and more preferably 1% by weight to 10% by weight, based on the mass of the polymer containing organooxysilyl end groups and the catalyst (B).

In the course of their studies, the inventors found that the presence of water is not necessarily required for the triggering of the condensation reaction, i.e. for the formation of Si-O-Si bridges between the functionalized polyol molecules, and can actually be damaging over and above a certain amount owing to the hydrolysis of organooxysilyl bonds. It is therefore preferable that, in step B), the mixture comprising all components that is heated has a water content of ≤100 ppm (preferably ≤50 ppm).

It is likewise in accordance with standard laboratory practice that step B) is performed in the absence of an organooxysilyl compound of the formula Si(X)ₙ(R₀)₄₋ₙ
where:
X is independently C1-C8-alkoxy, C7-C20-aralkoxy, C6-C14-aroxy, C7-C20-alkylaroxy, C1-C20-acyloxy;
R₀ is independently saturated or unsaturated C1-C22-alkyl, C6-C14-aryl, C7-C14-aralkyl, C7-C14-alkylaryl and
n is 2, 3 or 4.

In other words, the polymer containing organooxysilyl end groups which is to be used is purified before step B) and especially freed of organooxysilyl compounds that could disrupt the condensation reaction in step B). “Absence” here means that the organooxysilyl compound are present at most in technically unavoidable traces and can no longer be detected, for example, in the 400 MHz ¹H NMR spectrum of a sample.

The invention likewise relates to an elastomer precursor obtainable by a process of the invention.

### EXAMPLES

The present invention is described further by the examples which follow, but without being limited thereto.

Polyols Used:

| | |
|---|---|
| PET-1 | poly(oxypropylene) polyol, difunctional, |
| | with an OH number of 112 mg_{KOH}/g |

Polyol A polyoxyalkylene polyol containing carbon-carbon double bonds, prepared by the method specified below

Alkylene Oxide:

| | |
|---|---|
| PO | propylene oxide (Chemogas NV, 99.9%) |

Monomer Containing Carbon-Carbon Double Bonds:

| | |
|---|---|
| MA | maleic anhydride (Sigma-Aldrich, 99%) |

Organooxysilyl Compounds Used:

| | |
|---|---|
| MeSi(OEt)₃ | methyltriethoxysilane, monofunctional organooxysilyl |
| | compound (Sigma-Aldrich, 99%) |
| Me₂Si(OEt)₂ | dimethyldiethoxysilane, difunctional organooxysilyl |
| | compound (Sigma-Aldrich, 97%) |
| Me₃Si(OEt) | trimethylethoxysilane, trifunctional organooxysilyl |
| | compound (Sigma-Aldrich, 98%) |
| Si(OEt)₄ | tetraethoxysilane, tetrafunctional organooxysilyl |
| | compound (Sigma-Aldrich, >99%) |
| MeSi(OMe)₃ | methyltrimethoxysilane, trifunctional organooxysilyl |
| | compound (Sigma-Aldrich, 98%) |
| MeSi(OAc)₃ | methyltriacetoxysilane, trifunctional organooxysilyl |
| | compound (Sigma-Aldrich, 90%) |

Catalysts Used:

| | |
|---|---|
| DMC | catalyst prepared according to example 6 of WO-A01/80994 |
| DBTL | dibutyltin dilaurate (Sigma-Aldrich Chemie GmbH, 95%) |
| BinDec | bismuth neodecanoate (Sigma-Aldrich Chemie GmbH, not |
| | stated) |
| DBU | diazabicycloundecene (Acros Organics, 98%) |
| FA | formic acid (Honeywell Fluka, 98-100%) |

Methods Used:

The increase in molecular weight of functionalized polyols through polycondensation was examined on a Physica MCR 501 rheometer from Anton Paar, equipped with a D-PP15 measuring system (plate/plate configuration with a plate spacing of 1 mm).

Each sample (0.5 g) of the functionalized polyol was mixed with catalyst on the rheometer plate of the rheometer and subjected to 10% shear at 80° C. and a dynamic oscillation of 1 Hz. Storage modulus (G′) and loss modulus (G″) were measured every 20 seconds over 120 minutes. The gel point chosen was the juncture at which storage modulus (G′) and loss modulus (G″) are of equal magnitude (G′/G″=1).

For ¹H NMR spectra, the sample was dissolved in deuterated chloroform and analyzed on a Bruker spectrometer (AV400, 400 MHz).

IR spectra were recorded on a Bruker spectrometer (Alpha P FT-IR).

Preparation of Polyol A (Polyoxyalkylene Polyol Containing Carbon-Carbon Double Bonds):

A polyoxyalkylene polyol containing carbon-carbon double bonds which is suitable in the method of the invention for the functionalization with organooxysilyl compound can be prepared by the following method:

Step α:

A 970 ml pressure reactor equipped with a sparging stirrer was initially charged with a mixture of DMC catalyst (according to example 6 of WO 01/80994 A1; 161 mg) and PET-1 (125 g) and this initial charge was stirred (800 rpm) at 130° C. for 30 minutes under a partial vacuum (50 mbar), with passage of argon through the reaction mixture.

Step β:

After injection of CO₂ to 15 bar, in the course of which a slight drop in temperature was observed, and re-attainment of a temperature of 130° C., 3.0 g of propylene oxide was metered in with the aid of an HPLC pump (3 ml/min). The reaction mixture was stirred (800 rpm) at 130° C. for 20 min. The addition of 3.0 g of propylene oxide was repeated a second and third time.

Step γ:

The temperature was kept at 100° C. by closed-loop control and, during the subsequent steps, the pressure in the pressure reactor was kept at 15 bar with the aid of a mass flow regulator by metering in further CO₂. While stirring, a further 355 g of a monomer mixture (14% by weight of maleic anhydride dissolved in propylene oxide) was metered in by means of an HPLC pump (3 ml/min), while continuing to stir the reaction mixture (800 rpm). After the addition of monomer mixture (14% by weight of maleic anhydride dissolved in propylene oxide) had ended, the reaction mixture was stirred at 100° C. for a further 60 min. The reaction was ended by cooling the pressure reactor in an ice bath, releasing the elevated pressure and analyzing the resulting product, adopting the methods described in WO 2015/032737 A1. The ¹H NMR spectrum of the polyol is shown in FIG. 1.

Molar ratio of carbonate groups to ether groups (e/f): 0.17

The proportion of carbonate units in the repeat units of the polyetherestercarbonate polyol (A_{carbonate} in %): 12.9

The proportion of the double bonds which result via the incorporation of the maleic anhydride in the repeat units of the polyetherestercarbonate polyol (A_{double bond} in % by weight): 10.0

Molecular weight (Mₙ in g/mol): 4421

Polydispersity: 1.2

### Comparative Example 1: Preparation of a Polymer Containing Organooxysilyl End Groups by Reacting an Unsaturated Polyoxyalkylene Polyol with a Bifunctional Organooxysilyl Compound (F=1) and Increasing the Molecular Weight of the Product Obtained

Step A:

In a 100 ml two-neck flask, polyol A (10.0 g) and trimethylmonoethoxysilane (20.0 g) were combined. The flask was then fitted with a reflux condenser heated to 110° C. The mixture was brought to reaction temperature, 110° C., while stirring (300 rpm), and DBU (1% by weight, 100 mg) was added. The reaction mixture was then stirred at 110° C. for a further 2 h. On conclusion of the reaction, the unreacted dimethyldiethoxysilane was removed under reduced pressure. The product was analyzed by NMR spectroscopy and IR spectroscopy, and the functionalization of the polyol was confirmed.

Step B:

For the condensation experiment, 0.5 g of the functionalized unsaturated polyoxyalkylene polyol was mixed with DBU (2% by weight, 10 mg) and used in the rheometer. No gel point was observed.

### Comparative Example 2: Preparation of a Polymer Containing Organooxysilyl End Groups by Reacting an Unsaturated Polyoxyalkylene Polyol with a Bifunctional Organooxysilyl Compound (F=2) and Increasing the Molecular Weight of the Product Obtained

Step A:

In a 100 ml two-neck flask, polyol A (10.0 g) and dimethyldiethoxysilane (20.0 g) were combined. The flask was then fitted with a reflux condenser heated to 110° C. The mixture was brought to reaction temperature, 110° C., while stirring (300 rpm), and DBU (1% by weight, 100 mg) was added. The reaction mixture was then stirred at 110° C. for a further 2 h. On conclusion of the reaction, the unreacted dimethyldiethoxysilane was removed under reduced pressure. The product was analyzed by NMR spectroscopy and IR spectroscopy, and the functionalization of the polyol was confirmed.

Step B:

For the condensation experiment, 0.5 g of the functionalized unsaturated polyoxyalkylene polyol was mixed with DBU (2% by weight, 10 mg) and used in the rheometer. No gel point was observed.

### Example 3: Preparation of a Polymer Containing Organooxysilyl End Groups by Reacting an Unsaturated Polyoxyalkylene Polyol with a Trifunctional Organooxysilyl Compound (F=3) and Increasing the Molecular Weight of the Product Obtained

Step A:

In a 100 ml two-neck flask, polyol A (10.0 g) and methyltriethoxysilane (20.0 g) were combined. The flask was then fitted with a reflux condenser heated to 110° C. The mixture was brought to reaction temperature, 110° C., while stirring (300 rpm), and DBU (1% by weight, 100 mg) was added. The reaction mixture was then stirred at 110° C. for a further 2 h. On conclusion of the reaction, the unreacted methyltriethoxysilane was removed under reduced pressure. The product was analyzed by NMR spectroscopy and IR spectroscopy, and the functionalization of the polyol was confirmed.

Step B:

For the condensation experiment, 0.5 g of the functionalized unsaturated polyoxyalkylene polyol was mixed with 1% by weight of DBU and used in the rheometer. The gel point occurred after 89.3 min. The storage modulus G′ measured after 1 hour was 12.7 Pa.

### Example 4: Preparation of a Polymer Containing Organooxysilyl End Groups by Reacting an Unsaturated Polyoxyalkylene Polyol with a Trifunctional Organooxysilyl Compound (F=3)

Step A:

In a 100 ml two-neck flask, polyol A (10.0 g) and methyltrimethoxysilane (20.0 g) were combined. The flask was then fitted with a reflux condenser heated to 110° C. The mixture was brought to reaction temperature, 110° C., while stirring (300 rpm), and DBU (1% by weight, 100 mg) was added. The reaction mixture was then stirred at 110° C. for a further 2 h. On conclusion of the reaction, the unreacted methyltrimethoxysilane was removed under reduced pressure. The product was analyzed by NMR spectroscopy and IR spectroscopy, and the functionalization of the polyol was confirmed.

### Example 5: Preparation of a Polymer Containing Organooxysilyl End Groups by Reacting an Unsaturated Polyoxyalkylene Polyol with a Tetrafunctional Organooxysilyl Compound (F=4) and Increasing the Molecular Weight of the Product Obtained

Step A:

In a 100 ml two-neck flask, polyol A (10.0 g) and tetraethoxysilane (20.0 g) were combined. The flask was then fitted with a reflux condenser heated to 110° C. The mixture was brought to reaction temperature, 110° C., while stirring (300 rpm), and DBU (1% by weight, 100 mg) was added. The reaction mixture was then stirred at 110° C. for a further 2 h. On conclusion of the reaction, the unreacted tetraethoxysilane was removed under reduced pressure. The product was analyzed by NMR spectroscopy and IR spectroscopy, and the functionalization of the polyol was confirmed.

Step B:

For the condensation experiment, 0.5 g of the functionalized unsaturated polyoxyalkylene polyol was mixed with DBU (1% by weight, 5 mg) and used in the rheometer. The gel point was observed after 31.5 min. The storage modulus G′ was noted after one hour. The curing characteristics are shown in FIG. 2. The label “G” in FIG. 2 refers to the storage modulus, the label “G” to the loss modulus; “t” denotes the time in seconds.

### Comparative Example 6: Condensation Experiment Using an Unsaturated Polyoxyalkylene Polyol

Step A:

In a flask, 9.0 g of polyol A and DBU (1% by weight, 90 mg) were mixed. The mixture was brought to reaction temperature (110° C.) while stirring (300 rpm). Then water (400 mg) was added to the reaction mixture. The reaction mixture was stirred for 2 h. On conclusion of the reaction, the volatile constituents were removed under reduced pressure.

Step B:

For the condensation experiment, 0.5 g of the unfunctionalized unsaturated polyoxyalkylene polyol was mixed with DBU (2% by weight, 10 mg) and used in the rheometer. No gel point was observed. This is in accordance with the assumption that the functionalized polyol does not have any reactive sites for formation of Si—O—Si groups.

### Comparative example 7: Preparation of a Polymer Containing Organooxysilyl End Groups by Reacting an Unsaturated Polyoxyalkylene Polyol with a Trifunctional Organooxysilyl Compound (F=3) Using Formic Acid as Catalyst

The procedure was analogous to example 2, except that the catalyst used was 1% by weight of FA and the reaction temperature was 95° C. IR spectroscopy analysis of the product showed that the O—H stretch vibration band around 3500 cm⁻¹ had not yet disappeared completely, and so incomplete reaction conversion under these conditions was concluded.

### Comparative Example 8: Preparation of a Polymer Containing Organooxysilyl End Groups by Reacting an Unsaturated Polyoxyalkylene Polyol with a Trifunctional Organooxysilyl Compound (F=3)

In a 100 ml two-neck flask, polyol A (10.0 g) and methyltrimethoxysilane (20.0 g) were combined. The flask was then fitted with a reflux condenser heated to 110° C. The mixture was brought to reaction temperature, 110° C., while stirring (300 rpm), and DBTL (1% by weight, 100 mg) was added. The reaction mixture was then stirred at 110° C. for a further 2 h. On conclusion of the reaction, the unreacted methyltrimethoxysilane was removed under reduced pressure. The product was analyzed by ¹H NMR spectroscopy and IR spectroscopy, but it was not possible to confirm the functionalization of the polyol.

### Comparative Example 9: Preparation of a Polymer Containing Organooxysilyl End Groups by Reacting an Unsaturated Polyoxyalkylene Polyol with a Trifunctional Organooxysilyl Compound (F=3)

In a 100 ml two-neck flask, polyol A (10.0 g) and methyltriethoxysilane (20.0 g) were combined. The flask was then fitted with a reflux condenser heated to 110° C. The mixture was brought to reaction temperature, 110° C., while stirring (300 rpm), and bismuth neodecanoate (1% by weight, 100 mg) was added. The reaction mixture was then stirred at 110° C. for a further 2 h. On conclusion of the reaction, the unreacted methyltriethoxysilane was removed under reduced pressure. The product was by ¹H NMR spectroscopy and IR spectroscopy, but it was not possible to confirm the functionalization of the polyol.

### Comparative Example 10: Preparation of a Polymer Containing Organooxysilyl End Groups by Reacting an Unsaturated Polyoxyalkylene Polyol with a Trifunctional Organooxysilyl Compound (F=3) and Increasing the Molecular Weight of the Product Obtained

In a 100 ml two-neck flask, polyol A (10.0 g) and methyltriacetoxysilane (20.0 g) were combined. The flask was then fitted with a reflux condenser heated to 110° C. The mixture was brought to reaction temperature, 110° C., while stirring (300 rpm), and DBU (1% by weight, 100 mg) was added. The reaction mixture was then stirred at 110° C. for a further 2 h. On conclusion of the reaction, the unreacted methyltriacetoxysilane was removed under reduced pressure. The product was by ¹H NMR spectroscopy and IR spectroscopy, but it was not possible to confirm the functionalization of the polyol.

TABLE 1
Overview of the results from the preparation of the elastomer precursor

| | | | Catalyst | m(Cat(A)) | m(Cat(B)) | Gel point | G′ (60 min) |
|---|---|---|---|---|---|---|---|
| Example | Si(X)ₙ(R)₄₋ₙ | n | (A) = (B) | [% by wt.] | [% by wt.] | [min] | [Pa] |
| 1 (comp.) | Me₃Si(OEt) | 1 | DBU | 1 | 1 | n.o. | n.o. |
| 2 (comp.) | Me₂Si(OEt)₂ | 2 | DBU | 1 | 1 | n.o. | n.o. |
| 3 | MeSi(OEt)₃ | 3 | DBU | 1 | 1 | 89.3 | 12.7 |
| 4 | MeSi(OMe)₃ | 3 | DBU | 1 | 1 | 84.5 | 13.0 |
| 5 | Si(OEt)₄ | 4 | DBU | 1 | 1 | 31.7 | 281 |
| 6 (comp.) | — | — | DBU | 0 | 1 | n.o. | n.o. |
| 7 (comp.) | MeSi(OEt)₃ | 3 | FA | 1 | — | n.o. | n.o. |
| 8 (comp.) | MeSi(OMe)₃ | 3 | DBTL | 1 | — | n.o. | n.o. |
| 9 (comp.) | MeSi(OMe)₃ | 3 | BinDec | 1 | — | n.o. | n.o. |
| 10 (comp.) | MeSi(OAc)₃ | 3 | DBU | 1 | — | n.o. | n.o. |

comp. = comparison;
n.o. = not observed

Comparative examples 1 and 2 show that, in the case of functionalization with mono- or bifunctional organosilyl groups, no crosslinking of the corresponding products can be achieved. Examples 6-9 and 11 show that the presence of an amine-based catalyst is a prerequisite for the success of both step A and step B. By contrast, the compounds listed in comparative examples 7-10 showed no catalytic activity.

### Example 12: Preparation of a Polymer Containing Organooxysilyl End Groups by Reacting an Unsaturated Polyoxyalkylene Polyol with a Tetrafunctional Organooxysilyl Compound (F=4) and Increasing the Molecular Weight of the Product Obtained

The functionalized and unsaturated polyoxyalkylene polyol prepared in example 5 was used for this condensation experiment.

For the condensation experiment, 0.5 g of the functionalized unsaturated polyoxyalkylene polyol was mixed with DBU (2% by weight, 10 mg) and used in the rheometer. The gel point was observed after 13.7 min. The storage modulus G═ was noted after one hour.

### Example 13: Preparation of a Polymer Containing Organooxysilyl End Groups by Reacting an Unsaturated Polyoxyalkylene Polyol with a Tetrafunctional Organooxysilyl Compound (F=4) and Increasing the Molecular Weight of the Product Obtained

The functionalized and unsaturated polyoxyalkylene polyol prepared in example 5 was used for this condensation experiment.

For the condensation experiment, 0.5 g of the functionalized unsaturated polyoxyalkylene polyol was mixed with DBU (4% by weight, 20 mg) and used in the rheometer. The gel point was observed after 7.0 min. The storage modulus G′ was noted after one hour.

### Example 14: Preparation of a Polymer Containing Organooxysilyl End Groups by Reacting an Unsaturated Polyoxyalkylene Polyol with a Tetrafunctional Organooxysilyl Compound (F=4) and Increasing the Molecular Weight of the Product Obtained

The functionalized and unsaturated polyoxyalkylene polyol prepared in example 5 was used for this condensation experiment.

For the condensation experiment, 0.5 g of the functionalized unsaturated polyoxyalkylene polyol was mixed with DBU (8% by weight, 40 mg) and used in the rheometer. The gel point was observed after 4.5 min. The storage modulus G′ was noted after one hour.

TABLE 2
Overview of the results from the preparation of the elastomer
precursor at different catalyst concentration of DBU in step B

| | | | Catalyst | m(Cat(A)) | m(Cat(B)) | Gel point | G′ (60 min) |
|---|---|---|---|---|---|---|---|
| Example | Si(X)ₙ(R)₄₋ₙ | n | (A) = (B) | [% by wt.] | [% by wt.] | [min] | [Pa] |
| 11 (comp.) | Si(OEt)₄ | 4 | DBU | 1 | 0 | n.o. | n.o. |
| 5 | Si(OEt)₄ | 4 | DBU | 1 | 1 | 31.7 | 281 |
| 12 | Si(OEt)₄ | 4 | DBU | 1 | 2 | 13.7 | 1695 |
| 13 | Si(OEt)₄ | 4 | DBU | 1 | 4 | 7.0 | 2825 |
| 14 | Si(OEt)₄ | 4 | DBU | 1 | 8 | 4.5 | 7405 |

Examples 5, 12-14 and comparative example 11 show not only that the presence of amine-based catalysts is essential, but also that the concentration of those same catalysts has an influence on the progression of the reaction and the properties of the resulting product.

1. A process for preparing a polymer containing organooxysilyl end groups, comprising:
A) reacting a polyoxyalkylene polyol containing carbon-carbon multiple bonds with an organooxysilyl compound of the formula Si(X)ₙ(R₀)₄₋ₙ in the presence of a catalyst,
where:
X is independently C1-C8-alkoxy, C7-C20-aralkoxy, C6-C14-aroxy, C7-C20-alkylaroxy, or C1-C20-acyloxy;
R₀ is independently saturated or unsaturated C1-C22-alkyl, C6-C14-aryl, C7-C14-aralkyl, or C7-C14-alkylaryl,
and n is 3 or 4.

2. The process as claimed in claim 1, wherein the carbon-carbon multiple bond-containing polyoxyalkylene polyol is obtained by an adding alkylene oxide, a carbon-carbon multiple bond containing monomer and CO₂ onto an H-functional starter substance in the presence of a double metal cyanide catalyst.

3. The process as claimed in claim 2, wherein the carbon-carbon multiple bond-containing monomer is present in an amount of ≥0.1% by weight to ≤60% by weight, based on the total molar amount of alkylene oxide, carbon dioxide and the carbon-carbon multiple bond-containing monomer used.

4. The process as claimed in claim 2, wherein the at least one carbon-carbon multiple bond-containing monomer comprises:
(a) allyl glycidyl ether, vinylcyclohexene oxide, cyclooctadiene monoepoxide, cyclododecatriene monoepoxide, butadiene monoepoxide, isoprene monoepoxide, limonene oxide, 1,4-divinylbenzene monoepoxide, 1,3-divinylbenzene monoepoxide, a glycidyl ester of an unsaturated fatty acid, a partly epoxidized fat, a partly oxidized oil, or a mixture of any two or more thereof;
(b) an alkylene oxide of the general formula (IX): 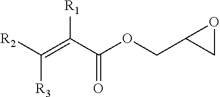
where R₁ to R₃ are independently H, a halogen, a substituted or unsubstituted C1-C22 alkyl, or a substituted or unsubstituted C6-C12 aryl;
(c) a cyclic anhydride of the general formula (X), (XI) or (XII): 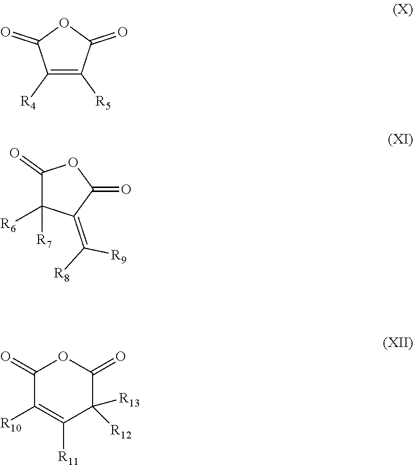
where R₁ to R₁₀ are independently H, a halogen, a substituted or unsubstituted C1-C22 alkyl, or substituted or unsubstituted C6-C12 aryl,
(d) 4-cyclohexene-1,2-dioic anhydride, 4-methyl-4-cyclohexene-1,2-dioic anhydride, 5,6-norbornene-2,3-dioic anhydride, allyl-5,6-norbornene-2,3-dioic anhydride, dodecenylsuccinic anhydride, tetradecenylsuccinic anhydride, hexadecenylsuccinic anhydride, octadecenylsuccinic anhydride, or a mixture of any two or more thereof; or
(e) an alkylene oxide of the general formula (XIII): 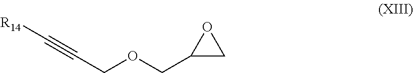
where R₁₄ is a saturated or unsaturated C1-C22-alkyl, C6-C14-aryl, C7-C14-aralkyl, or C7-C14-alkylaryl.

5. The process as claimed in claim 4, wherein the at least one carbon-carbon multiple bond-containing monomer comprises:
(a) allyl glycidyl ether, vinylcyclohexene oxide and limonene oxide,
(b) glycidyl acrylate and glycidyl methacrylate,
(c) maleic anhydride, itaconic anhydride, and cis-1,2,3,6-tetrahydrophthalic anhydride,
(d) 4-cyclohexene-1,2-dioic anhydride and 5,6-norbornene-2,3-dioic anhydride, or
(e) glycidyl propargyl ether.

6. The process as claimed in claim 1, wherein the polyoxyalkylene polyol containing carbon-carbon multiple bonds comprises a polyethercarbonate polyol containing carbon-carbon multiple bonds in which the polyethercarbonate polyol has a CO₂ content of 3% by weight to 44% by weight.

7. The process as claimed in claim 1, wherein the organooxysilyl compound comprises trimethoxysilane, methyltrimethoxysilane, phenyltrimethoxysilane, triethoxysilane, methyltriethoxysilane, methyltripropoxysilane, hexadecyltrimethoxysilane, octodecyltrimethoxysilane, noctyltrimethoxysilane, n-octyltriethoxysilane, propyltrimethoxysilane, propyltriethoxysilane, N-butyltrimethoxysilane, n-butyltriethoxysilane, iso-butyltriethoxysilane, 3-chloropropyltrimethoxysilane, 3-chloropropyltriethoxysilane, 3-chloropropylmethyldiethoxysilane, chloromethyltrimethoxysilane, chloromethyltriethoxysilane, dichloromethyltriethoxysilane, tetramethoxysilane, tetraethoxysilane, tetraisopropoxysilane or a combination of any two or more thereof.

8. The process as claimed in claim 7, wherein the organooxysilyl compound comprises trimethoxysilane, triethoxysilane, tetramethoxysilane, tetraethoxysilane, tetraisopropoxysilane, or a combination of any two or more thereof.

9. The process as claimed in claim 1, wherein the catalyst present in step A) comprises:
(a) an amine of the general formula (XIV): 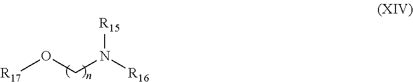
where:
R₁₅ and R₁₆ are independently hydrogen, alkyl or aryl; or
R₁₅ and R₁₆ together with the nitrogen atom supporting-them form an aliphatic, unsaturated or aromatic heterocycle;
n is an integer from 1 to 10;
R₁₇ is hydrogen, alkyl, aryl, or (CH2)x—N(R18)(R19) where:
R18 and R19 are independently hydrogen, alkyl or aryl; or
R18 and R19 together with the nitrogen atom supporting them form an aliphatic, unsaturated or aromatic heterocycle; and
x is an integer 5 from 1 to 10;
(b) an amine of the general formula (XV): 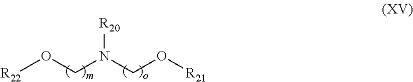
where:
R₂₀ is hydrogen, alkyl or aryl;
R₂₁ and R₂₂ are independently hydrogen, alkyl or aryl;
m and o are independently an integer from 1 to 10;
and/or:
(c) diazabicyclo[2.2.2]octane, diazabicyclo[5.4.0]undec-7-ene, dialkylbenzylamine, dimethylpiperazine, 2,2′-dimorpholinyl diethyl ether, 4-dimethylaminopyridine and/or pyridine.

10. The process as claimed in claim 9, wherein the catalyst present in step A) comprises diazabicyclo[2.2.2]octane, diazabicyclo[5.4.0]undec-7-ene 4-dimethylaminopyridine, or a combination of any two or more thereof.

11. A polymer containing organooxysilyl end groups, obtained by the process as claimed in claim 1, wherein the organoalkoxysilyl end groups have a number-average molecular weight Mn of ≥500 g/mol to ≤100000 g/mol, determined by means of gel permeation chromatography according to DIN 55672-1.

12. A process for preparing an elastomer precursor, comprising :
B) heating the polymer containing organooxysilyl end groups as claimed in claim 11 to a temperature of ≥65° C. in the presence of a catalyst.

13. The process as claimed in claim 12, wherein the catalyst present in step B) comprises:
(a) an amine of the general formula (XIV): 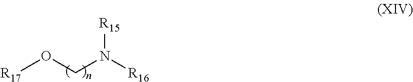
where:
R₁₅ and R₁₆ are independently hydrogen, alkyl or aryl; or
R₁₅ and R₁₆ together with the nitrogen atom supporting them form an aliphatic, unsaturated or aromatic heterocycle;
n is an integer from 1 to 10;
R₁₇ is hydrogen, alkyl, aryl, or (CH2)x—N(R18)(R19) where:
R18 and R19 are independently hydrogen, alkyl or aryl; or
R18 and R19 together with the nitrogen atom supporting them form an aliphatic, unsaturated or aromatic heterocycle;
x is an integer from 1 to 10;
(b) an amine of the general formula (XV): 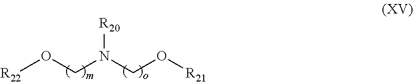
where:
R₂₀ is hydrogen, alkyl or aryl;
R₂₁ and R₂₂ are independently hydrogen, alkyl or aryl;
m and o are independently an integer from 1 to 10; and/or
(c) diazabicyclo[2.2.2]octane, diazabicyclo[5.4.0]undec-7-ene, dialkylbenzylamine, dimethylpiperazine, 2,2′-dimorpholinyl diethyl ether, 4-dimethylaminopyridine, pyridine, or a combination of any two or more thereof.

14. The process as claimed in claim 13, wherein the catalyst present in step B) comprises diazabicyclo[2.2.2]octane, diazabicyclo[5.4.0]undec-7-ene 4-dimethylaminopyridine, or a combination of any two or more thereof.

15. An elastomer precursor obtained by the process as claimed in claim 12.
